(19) United States
(12) Patent Application Publication
(10) Pub. No.: US 2015/0254054 A1
(43) Pub. Date: Sep. 10, 2015

(54) Audio Signal Processing

(71) Applicant: Dolby Laboratories Licensing Corporation, San Francisco, CA (US)

(72) Inventors: Xuejing Sun, Beijing (CN); Bin Cheng, Beijing (CN); Claus Bauer, Beijing (CN); Lie Lu, Beijing (CN); Guilin Ma, Beijing (CN)

(73) Assignee: Dolby Laboratories Licensing Corporation, San Francisco, CA (US)

(21) Appl. No.: 14/630,869

(22) Filed: Feb. 25, 2015

Related U.S. Application Data
(60) Provisional application No. 61/968,080, filed on Mar. 20, 2014.

(30) Foreign Application Priority Data
Mar. 4, 2014 (CN) 201410090572.3

(51) Int. Cl. G06F 3/16; G05B 15/02

(52) U.S. Cl. CPC G06F 3/165; G05B 15/02

(57) ABSTRACT

A method for audio signal processing is provided. The method includes acquiring a first set of metadata associated with consumption of an audio signal by a target user, acquiring a second set of metadata associated with a set of reference users and generating, at least partially based on the first and second sets of metadata, a recommended configuration of at least one parameter for the target user, the at least one parameter being for use in the consumption of the audio signal. Corresponding apparatus and computer program product are also disclosed.

### CROSS REFERENCE TO RELATED APPLICATIONS

This application claims the benefit of priority to Chinese Patent Application No. 201410090572.3 filed Mar. 4, 2014 and U.S. Provisional Application No. 61/968,080 filed Mar. 20, 2014 which is incorporated herein by reference in its entirety.

### Technology

Example embodiments disclosed herein generally relate to audio signal processing, and more specifically, to hybrid configuration recommendations for audio signal processing.

### BACKGROUND

When streaming online audio and/or playing back the audio on the local device, it is usually necessary to apply some post processing or sound effects. For example, the audio processing applied to the audio signal may include, but not limited to, noise reduction and compensation, equalization, volume leveling, binaural virtualization, ambience extraction, synthesis, and so forth.

Conventional audio processing applies a set of predefined parameters to the audio signal. It would be appreciated that the predefined parameters are only able to provide limited sound effects which might not meet the requirements of individual users. Also, some of the predefined parameters are hard-coded into the device and therefore cannot be adapted to the audio signal being processed and/or other dynamic factors. To address this problem, several known solutions enable real-time analysis and processing, such as volume leveling, on the playback device. However, local playback devices, especially those potable user terminals, often have limited processing power and/or resource such as memory, which limits the use of sophisticated processing and algorithms. Moreover, in order to meet the low-latency requirement of real-time online processing, the accuracy and quality of the audio signal processing have to be traded off.

Some solutions have been proposed to dynamically adapt the configuration of audio processing algorithms, for example, as a function of the audio content being processed. As an example, classification algorithms can be used to classify the audio content into different content classes such as speech, music, movie, and so forth. Then the audio processing can be controlled according to the content class of the processed audio, such that the most appropriate parameter values are selected. In such known solutions, however, only the audio content being processed is used to configure the audio processing algorithms without taking into account the information about the devices, environments, or behavior of the target user, much less the characteristics of other relevant users. As a result, the recommended configuration of parameter(s) is often not optimal.

In view of the foregoing, there is a need in the art for a solution that enables more accurate and adaptive recommendation for configuration of audio signal processing.

### SUMMARY

In order to address the foregoing and other potential problems, Example embodiments disclosed herein proposes a method, apparatus and computer program product for audio signal processing.

In one aspect, example embodiments provide a method for audio signal processing. The method includes acquiring a first set of metadata associated with consumption of an audio signal by a target, acquiring a second set of metadata associated with a set of reference and generating, at least partially based on the first and second sets of metadata, a recommended configuration of at least one parameter for the target, the at least one parameter being for use in the consumption of the audio signal. Embodiments in this regard further comprise a corresponding computer program product.

In another aspect, example embodiments provide an apparatus for processing audio signal. The apparatus includes a first metadata acquiring unit configured to acquire a first set of metadata associated with consumption of an audio signal by a target, a second metadata acquiring unit configured to acquire a second set of metadata associated with a set of reference and a configuration recommending unit configured to generate, at least partially based on the first and second sets of metadata, a recommended configuration of at least one parameter for the target, the at least one parameter being for use in the consumption of the audio signal.

Through the following description, it would be appreciated that in accordance with example embodiments disclosed herein, the content based recommendation and data based recommendation are integrated to generate a recommended configuration of one or more parameters for processing the audio signal. It will be appreciated that utilizing information concerning the audio content, device, environment and/or the user preference, it is possible to make relatively accurate and reliable recommendation even in the absence of sufficient user data.

### DESCRIPTION OF DRAWINGS

Through the following detailed description with reference to the accompanying drawings, the above and other objectives, features and advantages of example embodiments disclosed herein will become more comprehensible. In the drawings, several example embodiments will be illustrated in an example and non-limiting manner, wherein:

FIG. 1 illustrates a block diagram of a system in which example embodiments may be implemented;

FIG. 2 illustrates a flowchart of a method for audio signal processing in accordance with example embodiments;

FIG. 3 illustrates a flowchart of a method for acquiring the metadata associated with the reference users in accordance with example;

FIG. 4 illustrates a flowchart of a method for generating the recommended configuration of parameter(s) in accordance with some example;

FIG. 5 illustrates a block diagram of an apparatus for audio signal processing in accordance with example embodiments; and

FIG. 6 illustrates a block diagram of an example computer system suitable for implementing example embodiments.

Throughout the drawings, the same or corresponding reference symbols refer to the same or corresponding parts.

### DESCRIPTION OF EXAMPLE EMBODIMENTS

Principles of the example embodiments disclosed herein will now be described with reference to various example embodiments illustrated in the drawings. It should be appreciated that depiction of these embodiments is only to enable those skilled in the art to better understand and further implement the present invention, not intended for limiting the scope of the present invention in any manner.

Core inventive idea of the present invention is to propose a hybrid recommendation for the configuration for audio signal processing. More specifically, in accordance with example embodiments of the present invention, the characteristics of the target user may be adaptively integrated with the characteristics of one or more other users. By taking into account information of other users, the configuration recommendation may converge onto the user's desire more efficiently. In the meantime, by utilizing information concerning the audio content, device, environment and/or user preference, it is possible to make relatively accurate and reliable recommendation even in the absence of sufficient user data.

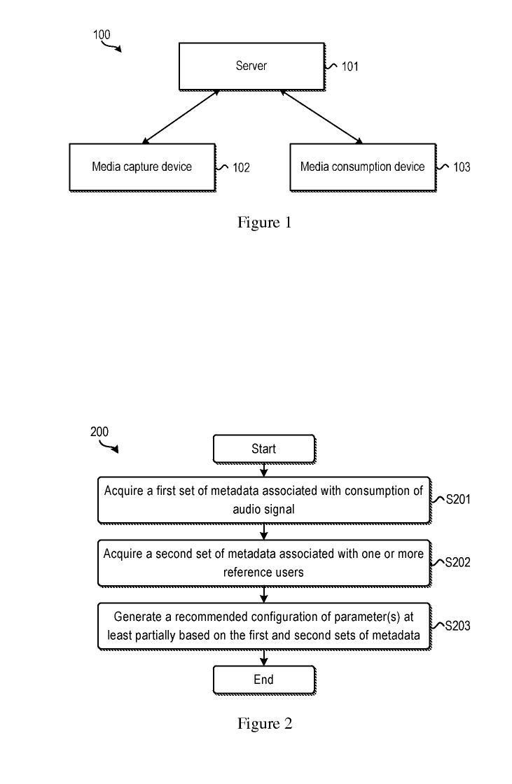

Reference is now made to FIG. 1 which shows a system 100 in which example embodiments of the present invention may be implemented. As shown, the system 100 comprises a server 101. In accordance with example embodiments of the present invention, the server 101 may be implemented by any suitable machine and may be equipped with sufficient resources such as the signal processing power and storage. In those embodiments where the system 100 is implemented based on the cloud infrastructure, the server 101 may be a cloud server.

The system 100 may further comprise a media capture device 102 and a media consumption device 103, both of which are connected to the server 101. In some example embodiments, the media capture device 102 and/or the media consumption device 103 may be implemented by portable devices such as mobile phones, personal digital assistances (PDAs), laptops, tablet computers, and so forth. Alternatively, the media capture device 102 and/or the media consumption device 103 may be implemented by fix machines such as workstations, personal computers (PCs), or any other suitable computing systems.

In accordance with example embodiments of the present invention, information may be communicated within the system 100 by means of, for example, a communication network such as a radio frequency (RF) communication network, a computer network such as a local area network (LAN), a wide area network (WAN) or the Internet, a near field communication connection, or any combination thereof. Moreover, the connections between the server 101 and the devices 102 and 103 may be wired or wireless. The scope of the invention is not limited in this regard.

In accordance with example embodiments of the present invention, the media capture device 102 is configurable to capture media content such as audio and video. The captured audio signal and other media content may be uploaded form the media capture device 102 to the server 101. The media consumption device 103 is configurable to consume the media content either locally or through real time streaming from the server 101. As used herein, the term “consumption” refers to any use of the audio signal such as playback.

In accordance with example embodiments of the present invention, in addition to audio signal and possibly other media content, the media capture device 102 is further configurable to acquire and upload to the server 101 the metadata associated with the capture of the audio signal (referred to as “capture metadata.”) The capture metadata may be acquired by any suitable technologies such as various sensors. The capture metadata may be acquired periodically, continuously, or in response to user commands. Alternatively or additionally, some or all of the metadata may be entered by a user of the media capture device 102. The user may input information into the media capture device 102 by means of pointing devices like mouse, keyboard or keypad, track ball, stylus, finger, voice, gesture, or any other interaction tools. As an example, after capturing a clip of audio content, the user may supply one or more labels indicating information concerning the captured audio content.

In some example embodiments, the capture metadata may comprise content metadata describing content of the captured audio signal. For example, the content metadata may include information about the length, class, acoustic features, waveforms, and/or any other time-domain or frequency-domain features of the audio signal.

Alternatively or additionally, the capture metadata may comprise device metadata that describes one or more properties of the media capture device 102. For example, such device metadata may describe the type, resources, settings, configuration of the functions, and/or any other aspects of the media capture device 102 that may impact the user experience in the media capture process.

Alternatively or additionally, the capture metadata may comprise environment metadata that describes the environment where the media capture device 102 is located. For example, the environment metadata may include information concerning the noise or visual profile of the environment, geographical location where the media content is captured, and/or time information such as the daytime at which media content is captured.

Alternatively or additionally, the capture metadata may comprise user metadata that describes the characteristics of the user of the media capture device 102. For example, the user metadata may include information describing the behavior of the user when capturing the media content, such as the user's mobility, gesture, and so forth. The user metadata may further comprise preference information concerning the preferred settings, configuration, and/or content class of the user.

Similar to the media capture device 102, in accordance with example embodiments of the present invention, the media consumption device 103 is also configurable to acquire and upload to the server 101 the metadata associated with the consumption of the audio signal on the media consumption device 103 (referred to as “consumption metadata.”) The consumption metadata may as well include content metadata, device metadata, environment metadata and/or user metadata, as described above. It should be noted that all the features as discussed with regard to the capture metadata are applicable to the consumption metadata and will not be repeated here.

In accordance with example embodiments of the present invention, the server 101 may collect and analyze the metadata from at least one of the media capture device 102 and the media consumption device 103. Example embodiments in this regard will be discussed below.

Although some embodiments will be described with reference to the system 100 as shown in FIG. 1, it should be noted that the scope of the present invention is not limited in this regard. For example, instead of the cloud-based infrastructure, example embodiments of the present invention may be implemented on stand-alone machines. In such embodiments, the media capture device 102 and media consumption device 103 may directly communicate with each other, and the server 101 may be omitted. In other words, the system 100 may be implemented on a peer-to-peer basis. Moreover, a single physical device may function as both the media capture device 102 and the media consumption device 103.

FIG. 2 shows a flowchart of a method 200 for generating a configuration recommendation for processing audio signal in accordance with example embodiments of the present invention. In some example embodiments, the method 200 may be performed at the server 101 as discussed with reference to FIG. 1. Alternatively, in some other embodiments, the method 200 may be performed at the media consumption device 103, for example.

After the method 200 starts, at step S201, a first set of metadata associated with consumption of the audio signal (that is, consumption metadata) is acquired. For the sake of discussion, the user who consumes the audio signal will be referred to as “target user.” It would be appreciated that the first set of metadata acquired at step S201 includes the “consumption metadata” that are obtained, for example, by the media consumption device 103 shown in FIG. 1.

The first set of metadata may include content metadata, device metadata, environment metadata and/or user metadata, as discussed above. For examples, the first set of metadata may include information concerning one or more of the following: length, class, size, and/or file format of the captured audio signal, audio type (mono, stereo or multichannel), environment type (such as office, train, bar, restaurant, aircraft, airport, and so forth), noise spectrogram, playback mode (headphone or loudspeaker), type/response/number of the headphone and/or speaker, preference and/or behavior of the target user, computing power, battery status and/or network bandwidth of the target device, and so forth.

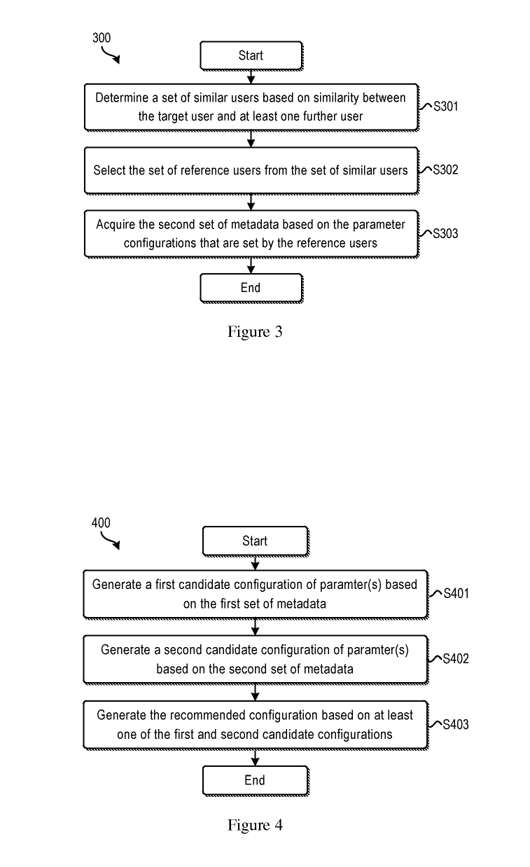

At step S202, a second set of metadata associated with a set of reference users is acquired. As used herein, a “reference user” refers to the one who has registered with the system and is possibly relevant to the target user. In order to improve the accuracy of the recommendation, in some example embodiments, the set of reference users may be determined based on similarities among the users. In this regard, FIG. 3 shows a flowchart of a method 300 for acquiring the second set of metadata associated with reference users in accordance with some example embodiments of the present invention. It would be appreciated that the method 300 is an example implementation of step S202 of the method 200.

As shown in FIG. 3, at step S301, a set of similar users is determined based on similarity between the target user and at least one further user. In some example embodiments, for example, the set of similar users may contain a certain number of users who are most similar to the target user. Metrics that may be used to measure the similarity among users may include the preference, behavior, device, status, environment, demographical information, and/or any other aspects of the users. In some example embodiments, the users may be clustered based on one or more of such metrics, such that the users within each resulting group are similar to one other. Alternatively or additionally, similarity between the target user and one or more further users may be calculated using methods such as Person correlation, vector cosine, and so forth. Those skilled in the art would readily appreciate that the determination of similar users with respect to the target user can be considered as a collaborative filtering (“CF”) process and many algorithms can be applied. The scope of the present invention is not limited in this regard.

Specifically, in some example embodiments, a reliability measurement may be derived to indicate whether and how the determination of similarity is reliable. For example, in those embodiments where the similarity among users is calculated using correlation algorithms, the variance of correlation coefficients may serve as the measurement of reliability. Such reliability may be associated with the candidate configuration of parameter(s) that is generated from the second set of metadata, which will be detailed below.

At step S302, the set of reference users may be selected from the similar users determined at step S301, such that each of the reference users has previously consumed at least one audio signal that is similar to the target audio signal. It should be noted that in the context of the present invention, the similar audio signals include the target audio signal per se. In other words, in such embodiments, the reference users are the ones who are similar to the target user and who has consumed the target audio signal or other similar audio signals.

In accordance with example embodiments of the present invention, the similarity of audio signals may be determined by any suitable approaches, no matter currently known or developed in the future. For example, the time-domain waveforms of the audio signals may be compared to determine the signal similarity. Alternatively or additionally, one or more frequency-domain features of the audio signals may be used to determine the signal similarity. Furthermore, in some example embodiments, content-based analysis may be performed to find the content similarity of the audio signals. Many algorithms are known in this regard and will not be detailed here. In some other embodiments, the labels or any other user-generated information about the audio signals may be taken into account when determining the similar audio signals.

The method 300 then proceeds to step S303, where the second set of metadata is acquired based on configurations of one or more parameters that are set by the reference users. For example, assume that the parameter to be set is the noise suppression aggressiveness which may be a value ranging from zero to one. Then values of the noise suppression aggressiveness that are adopted by the reference users may be retrieved as the metadata. As such, the second set of metadata describes how the reference users configure their respective device when they consumed the similar audio signals.

It should be noted that the method 300 is just an example embodiment of step S202. In some alternative embodiments, the reference users may be selected based on other rules. Specifically, if the target user is a new user or is an anonymous user who does not login, then some or all of the registered users may be selected as the reference users, for example. At this point, the information describing the parameter configurations previously set by these reference users may serve as the metadata in the second set.

Referring back to FIG. 2, the method 200 proceeds to step S203 to generate a recommended configuration of the parameter(s). In accordance with example embodiments of the present invention, generation of the recommended configuration is at least partially based on the first and second sets of metadata as acquired at step S201 and S202, respectively. FIG. 4 shows the flowchart of a method 400 for generating the recommended parameter configuration in accordance with some example embodiments of the present invention. It would be appreciated that the method 400 is an example implementation of step S203 of the method 200.

As shown in FIG. 4, at step S401, the first set of metadata associated with the target user is used to determine a first candidate configuration of the parameter(s). In some example embodiments, the first candidate configuration may be generated based on prior knowledge. For example, in some example embodiments, several representative profiles of user, device, and/or environment and their corresponding recommended configuration of one or more parameters may be stored in a knowledge base. The knowledge base may be maintained at the server 101 shown in FIG. 1, for example. In such embodiments, it is possible to retrieve the knowledge base with the first set of metadata to find a matching profile. Then the corresponding recommended configuration of parameters may be used as the first candidate configuration.

Alternatively or additionally, in those embodiments where the first set of metadata includes the content metadata, it is possible to perform content-based analysis to generate the first candidate configuration. For example, the content metadata indicating one or more acoustic features may be analyzed to identify the type of the audio signal. Then, the preferred parameter configuration for the determined type, which might be defined and stored in advance, may be retrieved to function as the first candidate configuration. The specific content analysis approaches may be task dependent. For example, an AdaBoost-based machine learning method may be employed to identify content type in order to perform dynamic equalization. As another example, the quality of audio signal may be analyzed in order to determine what signal processing operations could be applied to improve the audio quality. For example, it is possible to determine that specific operations should be turned on or off.

In some example embodiments, the first candidate configuration of parameter(s) may be associated with the respective reliability that indicates how the first candidate configuration is reliable. In some example embodiments, for example, the reliability may be defined in advance. Alternatively or additionally, the reliability may be provided by the content analysis process. As an example, the machine learning method will usually generate a confidence score for a particular prediction, and the reliability of the prediction may be derived from its accuracy on the development dataset. In another example embodiment, knowledge based auditory scene analysis may be applied to detect audio events, for example, in order to improve the volume leveling. This process will produce a plurality of correlation coefficients. The average and the variance of the correlation coefficients may provide a confidence score and a reliability measurement for the target audio event, respectively.

At step S402, the second set of metadata is used to derive a second candidate configuration of the parameter(s). Generally speaking, the second candidate configuration is on the basis of the configurations previously set by one or more reference users (for example, the users who are similar to the target user.) In some example embodiments, the second candidate configuration derived from the second set of metadata may also have associated reliability. As described above, in those embodiments where the reference users are selected from a set of similar users, the CF process used to find similar users may produce an indication that indicates whether the CF result is reliable. Such indication may be associated with the second candidate configuration as the reliability. As an example, in those embodiments where the correlation based CF process is applied, the variance of correlation coefficients may be used to indicate the reliability of the second candidate configuration.

The method 400 then proceeds to step S403, where the recommended configuration of the at least one parameter is generated based on at least one of the first and second candidate configurations. To this end, the first and second candidate configurations may be selected and/or combined in various manners.

In some example embodiments, one of the first and second candidate configurations may be selected as the recommended configuration. For example, in those embodiments where the first and second candidate configurations are associated with their respective reliability measurements, the candidate configuration with higher reliability may be determined as the recommended configuration of the parameter(s), while the candidate configuration with lower reliability is discarded.

Alternatively or additionally, the recommended configuration may be generated by combining the first and second candidate configurations in a suitable manner. For example, in some example embodiments, the parameter values in the first and second candidate configurations may be averaged, so that the recommended configuration is formed based on the average values of the parameter(s). Specifically, in those embodiments where the first and second candidate configurations are associated with the first reliability and the second reliability, respectively, values of a parameter in the first and second candidate configurations may be weighted averaged by using the reliability values as weighting factors.

It should be noted that the selection and combination of the first and second candidate configuration may be integrated in some example embodiments. For example, for a given parameter, the weighted average of its values in the first and second candidate configurations is taken as its value in the final recommended configuration. While for another parameter, its value may be determined according to the candidate configuration which has higher reliability.

It would be beneficial to generate the recommended configuration of parameter(s) based on both the first and second sets of metadata. By utilizing the consumption metadata associated with consumption of the audio signal, the configuration may be adapted to the specific situation of the device, environment, user's preference and/or the audio content, even in the absence of sufficient user data, for example, when the target user is new or anonymous in the system. In the meantime, by considering behavior/preference of other users, an accurate recommendation can be made in the case that the consumption metadata is not sufficient. Moreover, by use of the metadata associated with one or more other users, it is possible to provide serendipitous recommendations such that an audio processing or sound effect selected by other reference users can be recommended even though such an option may not match target user's profile or be requested by the target user.

It should be noted that the embodiments as discussed above are just for the purpose of illustration. Many variations can be made within the scope of the present invention. For example, in the embodiments described with reference to FIG. 2, acquiring of the first set of metadata is shown to be performed prior to the second set of metadata. It should be noted that the sequence of acquiring the first and second sets of metadata is not limited. Rather, different metadata can be acquired in any order or in parallel. Likewise, the first and second candidate configurations of parameter(s) may be generated in any order or in parallel.

Additionally, in the embodiments discussed above, the first and second candidate configurations are generated directly based on the first and second sets of metadata, respectively. In some alternative embodiments, an initial configuration of parameter(s) may be provided such that one or more candidate configurations are obtained based on the initial configuration. For example, it is possible to adjust the initial configuration with the respective metadata to generate one or more candidate configurations of parameter(s).

In some embodiments, the capture metadata, for example, acquired by the media capture device 102 as shown in FIG. 1, may be used to generate the initial configuration of parameter(s). It would be appreciated that the capture metadata might have influence on the consumption of the audio signal. For example, the microphone frequency response of the media capture device might be highly relevant to the subsequent audio processing such as the equalization. As another example, the location information acquired by the media capture device is capable of providing a useful context for the audio processing as well. For example, if the audio signal is captured near a train station, then it would be beneficial to have higher confidence to apply a train noise model in the noise suppression module/process. Therefore, it would be beneficial to establish the initial configuration of one or more processing parameters with the capture metadata (may be referred to as “a third set of metadata.”) In this way, it is possible to further improve the quality of post processing or sound effects of the audio signal. Similar to the consumption metadata, various processing and analysis may be applied to the capture metadata to generate the initial configuration of parameter(s), which will not be repeated here.

In accordance with example embodiments of the present invention, the recommended configuration will be applied to the respective parameter(s) to process the audio signal for consumption. In some example embodiments, the recommended configuration may be directly applied, for example, at the server 101 to process the audio signal. Then the processed audio signal may be streamed or otherwise transmitted to the media consumption device 103. In this manner, the processing load at the user end can be significantly reduced. Alternatively, the recommended configuration may be transmitted to the media consumption device 103, such that the recommended configuration may be applied at the user end, for example, in response to the user command.

It should be noted that example embodiments of the present invention are applicable to a variety of post processing of audio signals, including but not limited to noise suppression, noise compensation, volume leveling, dynamic equalization and any combination thereof. Only for the purpose of illustration, an example of noise suppression will be described. Assume a first user captured an audio clip using a known mobile device and uploaded the audio clip to the cloud. The uploaded metadata associated with the capture of the audio signal include:
Microphone information, such as type, frequency response, number of microphones, microphone distances, and microphone positions on the device. Such information is frequently employed in noise estimation and suppression algorithms.
Recording location; and
User-supplied label such as rain, lecture, and so forth.

Then content analysis may be applied to identify the content type of the captured audio signal. The input to the content analysis process may include one or more acoustic features derived from the audio content. Additionally, the input may include features such as recording location, user-supplied labels, and so forth. In this example, outcome of the content analysis is that the speech content confidence score is 0.5 and the reliability measure is 0.2. Since the confidence score shows that the audio signal might be speech dominant signal, noise suppression shall be applied. As a result, the initial configuration of parameters may be generated as follows:
Suppression aggressiveness 0.5;
Noise type: car noise (car noise, babble noise, road noise etc);
Noise stationarity: 0.5 (a continuous value in the range of [0,1]); and
Speech content confidence: 0.5 (a continuous value in the range of [0,1]).

When a second user attempts to stream the audio clip, for example, from the cloud, the consumption metadata associated with this target user may be collected, which in this example include:
Preference of the target user; and
Device information comprising computing power, battery status, network speed and playback mode (headphone or loudspeaker).

Based on the consumption metadata, the initial configuration may be adjusted as follows to generate the first candidate configuration of these parameters:
Suppression aggressiveness: 0.95;
Noise type: car noise;
Noise stationarity: 0.5; and
Speech content confidence: 0.5.

Assume that this audio clip has been consumed by 100 other users who have similar demographic profiles and preferences as the target user. It is found that the average aggressiveness selected by these users is 0.7. Or, alternatively, the majority of these users choose to lower the noise suppression aggressiveness to 0.7. Accordingly, in the second candidate configuration, the suggested value of suppression aggressiveness will be adjusted to be 0.7. When combining the first and second candidate configurations, considering the fact that the reliability associated with the first candidate configuration (0.2) is not high, the second candidate configuration will take priority. Therefore, the resulting recommended configuration of parameters is as follows:
Suppression aggressiveness: 0.7;
Noise type: car noise;
Noise stationarity: 0.5; and
Speech content confidence: 0.5.

Then, when a third user, who is an anonymous user, requests to consume this audio clip, no similar users can be found. In this event, the reference users may be all the registered users who have previously consumed this or similar audio clip. At this point, the reliability associated with the second candidate configuration will be 0.5. Assume that the value of the noise suppression aggressiveness in the second candidate configuration for the third user is 0.8. Since the reliability associated with the second candidate configuration is still higher than that of the first candidate configuration (0.2), the resulting recommended configuration of parameters is as follows:
Suppression aggressiveness: 0.8;
Noise type: car noise;
Noise stationarity: 0.5; and
Speech content confidence: 0.5

Example embodiments are also applicable to the noise compensation. Suppose a clip of captured audio content has been uploaded to the server. When a target user requests to stream the audio clip, consumption metadata concerning one or more of the following may be acquired:
Environment type (office, train, bar, restaurant, aircraft, airport, or the like);
Noise spectrogram;
Microphone information;
Playback mode (headphone or speaker);
Headphone/speaker type/response; and
Audio type (mono, stereo or multichannel).
   Based on the above consumption metadata, the following first candidate configuration may be generated, for example, by adjusting an initial configuration:
Noise compensation: ON;
Compensation level offset: 0 dB default;
Multichannel movie dialog enhancer: ON;
Movie dialog enhancement level offset: 0 dB offset;
Speech confidence score: 0.8 (a continuous value in the range of [0,1]); and
Speech to non-speech ratio: 8 dB.
   The reliability associated with the first candidate configuration is assumed to be 0.8.

Assume that the audio content has been consumed by other 10 users who have environmental noise profiles, headphone types and preferences similar to those of the target user. The second candidate configuration may be generated, for example, as follows:
Noise compensation: ON;
Compensation level offset: +5 dB;
Multichannel movie dialog enhancer: ON;
Movie dialog enhancement level offset: +2 dB offset;
Speech confidence score: 0.8; and
Speech to non-speech ratio: 5 dB.
   The reliability associated with the second candidate configuration is 0.2 since only data of ten reference users are available. Therefore, the first candidate configuration may take priority and is selected as the recommended configuration of parameters.

As another example, the hybrid recommendation according to embodiments of the present invention may be applied to volume leveling. For example, when a user requests to consume an audio clip, the first candidate configuration, in the form of a set of gains, may be generated based on the consumption metadata as follows, which provides device information (reference reproduction level), content information (confidence scores), as well as algorithm parameters (target reproduction level and the leveling amount for different contents):
Volume leveling: ON;
Portable device reference reproduction level: 75 dB;
Target reproduction level: −25 dB;
Speech confidence score and leveling aggressiveness for speech: 1; and
Noise confidence score and leveling aggressiveness for noise: 0.
   The reliability associated with the first candidate configuration is 0.1. Assume that the target user is a new user of the system. As a result, no similar users can be identified. If the audio clip has been consumed by other 1000 users in total, which leads to a reliability of 0.5, then the second candidate configuration will take priority. In some embodiments, the second candidate configuration may be generated based on the averaged gains used by the 1000 reference users, for example, as follows:
Leveling: ON;
Portable device reference reproduction level: 75 dB;
Target reproduction level: −22 dB;
speech confidence score and leveling aggressiveness for speech: 0.9; and
Noise confidence score and leveling aggressiveness for noise: 0.1.

Likewise, for dynamic equalization, it is possible to generate an initial configuration of a set of relevant gains based on the capture metadata, for example. Then when a target user requests to consume the audio clip, the initial configuration may be adjusted based on the consumption metadata to obtain the first candidate configuration, for example, as follows:
Dynamical equalization (DEQ): ON;
DEQ profile for music: Profile 1;
DEQ profile for movie: Profile 3;
Movie confidence score and DEQ aggressiveness for movie: 0.3; and
Music confidence score and DEQ aggressiveness for music: 1.0.
   The reliability associated with the first candidate configuration is 0.5. Assume that the audio clip has been consumed by 100 other users who have similar demographic profiles and preferences as the target user. The second candidate configuration may be generated based on the configurations of these 100 reference users. As an example, the second candidate configuration may be as follows:
DEQ: ON;
DEQ profile for music: Profile 1;
DEQ profile for movie: Profile 3;
Movie confidence score and DEQ aggressiveness for movie: 0.1; and
Music confidence score and DEQ aggressiveness for music: 0.9.
   Assume that the reliability associated with the second candidate configuration is also 0.5. In this event, the first and second candidate configurations may be combined. For example, the gain values may be averaged to obtain the final recommended configuration:
DEQ: ON;
DEQ profile for music: Profile 1;
DEQ profile for movie: Profile 3;
Movie confidence score and DEQ aggressiveness for movie: 0.2; and
Music confidence score and DEQ aggressiveness for music: 0.95.

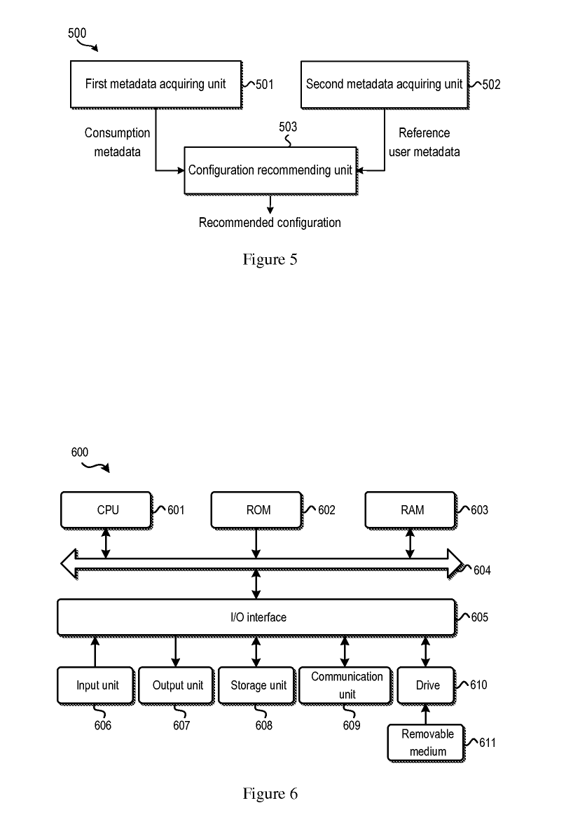

FIG. 5 shows a block diagram of an apparatus 500 for audio signal processing in accordance with example embodiments of the present invention. As shown, the apparatus 500 comprises: a first metadata acquiring unit 501 configured to acquire a first set of metadata associated with consumption of an audio signal by a target user; a second metadata acquiring unit 502 configured to acquire a second set of metadata associated with a set of reference users; and a configuration recommending unit 503 configured to generate, at least partially based on the first and second sets of metadata, a recommended configuration of at least one parameter for the target user, the at least one parameter being for use in the consumption of the audio signal.

In some example embodiments, the first set of metadata may include at least one of: content metadata describing the audio signal; device metadata describing a device of the target user; environment metadata describing environment in which the target user is located; and user metadata describing preference or behavior of the target user.

In some example embodiments, the apparatus 500 may further comprise: a similar user determining unit configured to determine a set of similar users based on similarity between the target user and at least one further user; and a reference user determining unit configured to determine the set of reference users from the set of similar users, such that each of the reference users has consumed at least one audio signal that is similar to the audio signal. In these example embodiments, the second metadata acquiring unit 502 may be configured to acquire the second set of metadata based on configurations of the at least one parameter that are set by the reference users.

In some example embodiments, the apparatus 500 further comprises: a first candidate configuration generating unit configured to generate a first candidate configuration of the at least one parameter at least partially based on the first set of metadata; and a second candidate configuration generating unit configured to generate a second candidate configuration of the at least one parameter at least partially based on the second set of metadata. In these example embodiments, the configuration recommending unit may be configured to generate the recommended configuration based on at least one of the first and second candidate configurations.

In some example embodiments, the recommended configuration of the at least one parameter is generated based on at least one of: a selection of the first and second candidate configurations; and a combination of the first and second candidate configurations. In some example embodiments, the first candidate configuration is associated with first reliability and the second candidate configuration is associated with second reliability. In these example embodiments, the combination is a weighted combination of the first and second candidate configurations based on the first reliability and the second reliability.

In some example embodiments, the apparatus 500 may further comprises: a third metadata acquiring unit configured to acquire a third set of metadata associated with capture of the audio signal; and an initial configuration generating unit configured to generate an initial configuration of the at least one parameter at least partially based on the third set of metadata. In these example embodiments, at least one of the first and second candidate configurations may be generated based on the initial configuration of the at least one parameter.

In some example embodiments, the apparatus 500 may further comprise: an audio processing unit configured to process the audio signal by applying the recommended configuration of the at least one parameter; and an audio transmitting unit configured to transmit the processed audio signal to a device of the target user. Alternatively or additionally, in some example embodiments, the apparatus 500 may comprise a recommendation transmitting unit configured to transmit the recommended configuration of the at least one parameter to a device of the target user such that the recommended configuration is applied at the device.

For the sake of clarity, some optional units of the apparatus 500 are not shown in FIG. 5. However, it should be appreciated that the features as described above with reference to FIGS. 1-4 are all applicable to the apparatus 500. Moreover, the units of the apparatus 500 may be a hardware module or a software unit module. For example, in some example embodiments, the apparatus 500 may be implemented partially or completely with software and/or firmware, for example, implemented as a computer program product embodied in a computer readable medium. Alternatively or additionally, the apparatus 500 may be implemented partially or completely based on hardware, for example, as an integrated circuit (IC), an application-specific integrated circuit (ASIC), a system on chip (SOC), a field programmable gate array (FPGA), and so forth. The scope of the present invention is not limited in this regard.

FIG. 6 shows a block diagram of a computer system 600 suitable for implementing example embodiments of the present invention. As shown, the computer system 600 comprises a central processing unit (CPU) 601 which is capable of performing various processes in accordance with a program stored in a read only memory (ROM) 602 or a program loaded from a storage unit 608 to a random access memory (RAM) 603. In the RAM 603, data required when the CPU 601 performs the various processes or the like is also stored as required. The CPU 601, the ROM 602 and the RAM 603 are connected to one another via a bus 604. An input/output (I/O) interface 605 is also connected to the bus 604.

The following components are connected to the I/O interface 605: an input unit 606 including a keyboard, a mouse, or the like; an output unit 607 including a display such as a cathode ray tube (CRT), a liquid crystal display (LCD), or the like, and a loudspeaker or the like; the storage unit 608 including a hard disk or the like; and a communication unit 609 including a network interface card such as a LAN card, a modem, or the like. The communication unit 609 performs a communication process via the network such as the internet. A drive 610 is also connected to the I/O interface 605 as required. A removable medium 611, such as a magnetic disk, an optical disk, a magneto-optical disk, a semiconductor memory, or the like, is mounted on the drive 610 as required, so that a computer program read therefrom is installed into the storage unit 608 as required.

Specifically, in accordance with embodiments of the present invention, the processes described above with reference to FIGS. 2-4 may be implemented as computer software programs. For example, embodiments of the present invention comprise a computer program product including a computer program tangibly embodied on a machine readable medium, the computer program including program code for performing methods 200, 300 and/or 400. In such embodiments, the computer program may be downloaded and mounted from the network via the communication unit 609, and/or installed from the removable medium 611.

Generally speaking, various example embodiments of the present invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present invention include a computer program product comprising a computer program tangibly embodied on a machine readable medium, the computer program containing program codes configured to carry out the methods as described above.

In the context of the disclosure, a machine readable medium may be any tangible medium that can contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present invention may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination.

Various modifications, adaptations to the foregoing example embodiments of this invention may become apparent to those skilled in the relevant arts in view of the foregoing description, when read in conjunction with the accompanying drawings. Any and all modifications will still fall within the scope of the non-limiting and example embodiments of this invention. Furthermore, other embodiments of the inventions set forth herein will come to mind to one skilled in the art to which these embodiments of the invention pertain having the benefit of the teachings presented in the foregoing descriptions and the drawings.

It will be appreciated that the embodiments of the present invention are not to be limited to the specific embodiments as discussed above and that modifications and other embodiments are intended to be included within the scope of the appended claims. Although specific terms are used herein, they are used in a generic and descriptive sense only and not for purposes of limitation.

What is claimed is:

1. A method for audio signal processing, the method comprising:
acquiring a first set of metadata associated with consumption of an audio signal by a target;
acquiring a second set of metadata associated with a set of references; and
generating a recommended configuration of at least one parameter for the target at least partially based on the first and second sets of metadata, the at least one parameter being for use in the consumption of the audio signal.

2. The method according to claim 1, wherein the first set of metadata includes at least one of:
content metadata describing the audio signal;
device metadata describing a device of the target;
environment metadata describing environment in which the target is located; and
user metadata describing preference or behavior of the target.

3. The method according to claim 1, wherein acquiring the second set of metadata comprises:
determining a set of similar users based on similarity between the target user and at least one further user;
determining the set of references from the set of similar users, such that each of the references has consumed at least one audio signal that is similar to the audio signal; and
acquiring the second set of metadata based on configurations of the at least one parameter that are set by the references.

4. The method according to any of claim 1, wherein generating the recommended configuration of the at least one parameter comprises:
generating a first candidate configuration of the at least one parameter at least partially based on the first set of metadata;
generating a second candidate configuration of the at least one parameter at least partially based on the second set of metadata; and
generating the recommended configuration based on at least one of the first and second candidate configurations.

5. The method according to claim 4, wherein the recommended configuration of the at least one parameter is generated based on at least one of:
a selection of the first and second candidate configurations; and
a combination of the first and second candidate configurations.

6. The method according to claim 5, wherein the first candidate configuration is associated with first reliability and the second candidate configuration is associated with second reliability, and wherein the combination is a weighted combination of the first and second candidate configurations based on the first reliability and the second reliability.

7. The method according to any of claim 4, further comprising:
acquiring a third set of metadata associated with capture of the audio signal; and
generating an initial configuration of the at least one parameter at least partially based on the third set of metadata,
wherein at least one of the first and second candidate configurations is generated based on the initial configuration of the at least one parameter.

8. The method according to any of claim 1, further comprising:
processing the audio signal by applying the recommended configuration of the at least one parameter; and
transmitting the processed audio signal to a device of the target.

9. The method according to any of claim 1, further comprising:
transmitting the recommended configuration of the at least one parameter to a device of the target such that the recommended configuration is applied at the device.

10. An apparatus for processing audio signal, the apparatus comprising:
a first metadata acquiring unit configured to acquire a first set of metadata associated with consumption of an audio signal by a target;
a second metadata acquiring unit configured to acquire a second set of metadata associated with a set of references; and
a configuration recommending unit configured to generate a recommended configuration of at least one parameter for the target, at least partially based on the first and second sets of metadata, the at least one parameter being for use in the consumption of the audio signal.

11. The apparatus according to claim 10, wherein the first set of metadata includes at least one of:
content metadata describing the audio signal;
device metadata describing a device of the target;
environment metadata describing environment in which the target is located; and
user metadata describing preference or behavior of the target.

12. The apparatus according to claim 10, further comprising:
a similar user determining unit configured to determine a set of similar users based on similarity between the target and at least one further user; and
a reference user determining unit configured to determine the set of references from the set of similar users, such that each of the references has consumed at least one audio signal that is similar to the audio signal,
wherein the second metadata acquiring unit is configured to acquire the second set of metadata based on configurations of the at least one parameter that are set by the references.

13. The apparatus according to any of claim 10, further comprising:
a first candidate configuration generating unit configured to generate a first candidate configuration of the at least one parameter at least partially based on the first set of metadata; and
a second candidate configuration generating unit configured to generate a second candidate configuration of the at least one parameter at least partially based on the second set of metadata,
wherein the configuration recommending unit is configured to generate the recommended configuration based on at least one of the first and second candidate configurations.

14. The apparatus according to claim 13, wherein the recommended configuration of the at least one parameter is generated based on at least one of:
a selection of the first and second candidate configurations; and
a combination of the first and second candidate configurations.

15. The apparatus according to claim 14, wherein the first candidate configuration is associated with first reliability and the second candidate configuration is associated with second reliability, and wherein the combination is a weighted combination of the first and second candidate configurations based on the first reliability and the second reliability.

16. The apparatus according to any of claim 13, further comprising:
a third metadata acquiring unit configured to acquire a third set of metadata associated with capture of the audio signal; and
an initial configuration generating unit configured to generate an initial configuration of the at least one parameter at least partially based on the third set of metadata,
wherein at least one of the first and second candidate configurations is generated based on the initial configuration of the at least one parameter.

17. The apparatus according to any of claim 10, further comprising:
an audio processing unit configured to process the audio signal by applying the recommended configuration of the at least one parameter; and
an audio transmitting unit configured to transmit the processed audio signal to a device of the target.

18. The apparatus according to any of claim 10, further comprising:
a recommendation transmitting unit configured to transmit the recommended configuration of the at least one parameter to a device of the target such that the recommended configuration is applied at the device.

19. A computer program product for audio signal processing, the computer program product being tangibly stored on a non-transient computer-readable medium and comprising machine executable instructions which, when executed, cause the machine to perform steps of the method according to any of claim 1.

20. An apparatus for audio signal processing, comprising:
at least one processor; and
at least one memory storing a computer program;
in which the at least one memory with the computer program is configured with the at least one processor to cause the apparatus to at least:
acquire a first set of metadata associated with consumption of an audio signal by a target;
acquire a second set of metadata associated with a set of references; and
generate a recommended configuration of at least one parameter for the target at least partially based on the first and second sets of metadata, the at least one parameter being for use in the consumption of the audio signal.
